(19) United States
(12) Patent Application Publication
(10) Pub. No.: US 2011/0216887 A1
(43) Pub. Date: Sep. 8, 2011

(54) FACSIMILE APPARATUS, FAILURE DETECTION METHOD, AND COMPUTER READABLE MEDIUM

(75) Inventor: Kenji NOMURA, Kanagawa (JP)

(73) Assignee: FUJI XEROX CO., LTD., Tokyo (JP)

(21) Appl. No.: 12/881,592

(22) Filed: Sep. 14, 2010

(30) Foreign Application Priority Data
Mar. 3, 2010 (JP) 2010-046705

(51) Int. Cl. H04M 1/00; H04M 1/24

(52) U.S. Cl. 379/32.01; 379/100.06

(57) ABSTRACT

A facsimile apparatus includes a first detecting unit and a second detecting unit. The a first detecting unit detects whether a facsimile communication is established or not with a communication destination in a prescribed time after a selection signal is sent to the communication destination with a communication line held. The second detecting unit detects a state of the communication line with the communication line held when the first detecting unit detects that a facsimile communication is not established.

### CROSS-REFERENCE TO RELATED APPLICATIONS

This application is based upon and claims priority under 35 USC 119 from Japanese Patent Application No. 2010-046705, filed Mar. 3, 2010.

### BACKGROUND

1. Technical Field

The present invention relates to a facsimile apparatus, a failure detection method, and a computer readable medium.

2. Related Art

There are two dial communication methods, that is, the push button method and the dial pulse method. When one of these methods is set erroneously in a telephone or the like, a communication is not performed.

### SUMMARY OF THE INVENTION

According to an aspect of the invention, a facsimile apparatus includes a first detecting unit and a second detecting unit. The a first detecting unit detects whether a facsimile communication is established or not with a communication destination in a prescribed time after a selection signal is sent to the communication destination with a communication line held. The second detecting unit detects a state of the communication line with the communication line held when the first detecting unit detects that a facsimile communication is not established.

### BRIEF DESCRIPTION OF THE DRAWINGS

Exemplary embodiments of the invention will be described in detail based on the following figures, wherein:

FIG. 1 shows the configuration of an example facsimile communication system to which a facsimile apparatus and a failure detection program according to an exemplary embodiment of the present invention are applied;

FIG. 2 shows the functional configuration of the facsimile apparatus according to the exemplary embodiment of the invention;

FIG. 3 is a flowchart of a process which is executed by the facsimile apparatus according to the exemplary embodiment of the invention; and

FIG. 4 is a flowchart of another process which is executed by the facsimile apparatus according to the exemplary embodiment of the invention.

### DETAILED DESCRIPTION

A facsimile apparatus and a failure detection program according to an exemplary embodiment of the present invention will be hereinafter described with reference to the accompanying drawings.

### Exemplary Embodiment

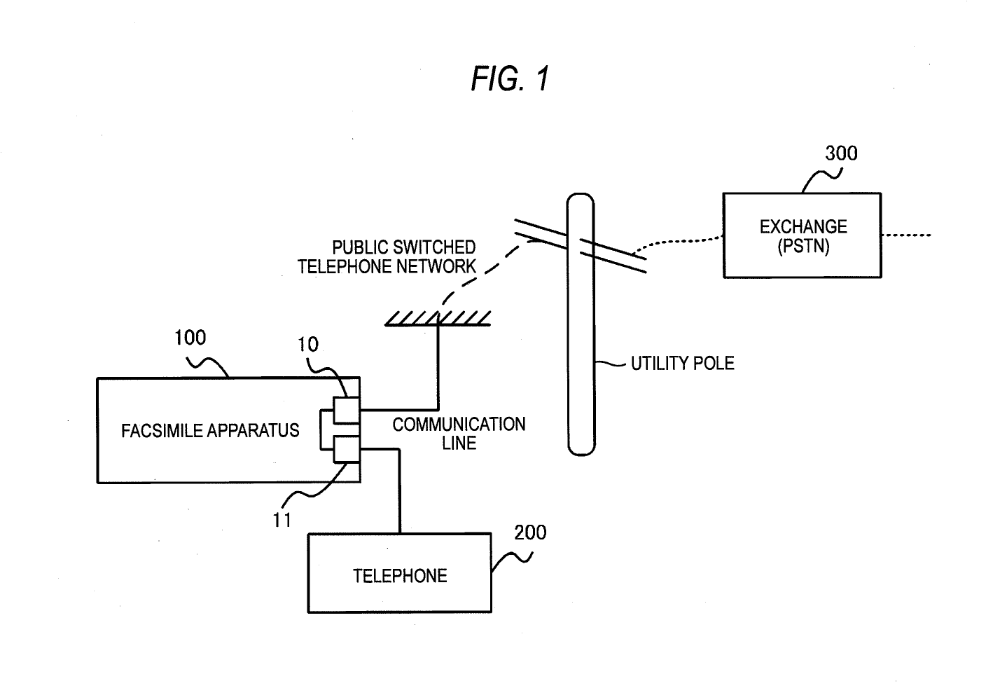

FIG. 1 shows the configuration of an example facsimile communication system to which the facsimile apparatus and the failure detection program according to the exemplary embodiment of the invention are applied.

The system of FIG. 1 is provided with a facsimile apparatus 100, a telephone 200, and an exchange 300 which is provided in a telephone office. The facsimile apparatus 100 is equipped with a telephone communication port 11 for connection to the telephone 200 and an external line connection port 10 for connection to a communication line of a public switched telephone network (PSTN) which uses the exchange 300.

The facsimile apparatus 100 has a facsimile transfer function of transferring image data obtained by reading a document to a facsimile transmission destination (communication destination) corresponding to a dial number that is specified by the user's manipulation of a display panel or the like.

Image data that is transferred from the facsimile apparatus 100 by the facsimile transfer function is relayed to the public switched telephone network via the communication line and transmitted to the exchange 300. The exchange 300 performs routing for transferring the image data to the communication destination corresponding to the specified dial number, and transfers the image data to another exchange 300 on the path determined by the routing or a communication destination facsimile apparatus.

The facsimile apparatus 100 also has a communication switching function (hereinafter referred to as a relay function). When receiving an electrical signal directed to the telephone 200 via the public switched telephone network, the facsimile apparatus 100 enables a telephone call using the telephone 200 by relaying the electrical signal to the telephone 200 by means of the relay function.

In the facsimile apparatus 100, when a dial number of a communication destination facsimile apparatus and a start button is pushed to facsimile-transfer image data, a selection signal is generated on the basis of the dial number and sent to the communication destination.

As a result, the facsimile apparatus 100 is rendered in a state of waiting for a response from the communication destination, that is, a communication state for accepting only a communication signal from the communication destination corresponding to the dial number. From this time onward, a communication holding state is maintained, whereby a communication with any other facsimile apparatus is disabled.

When a T1 timeout which is an event that a communication (also called communication session) with the communication destination is not established is detected in this state, a voltage of the communication line to be used for the communication with the communication destination is checked through a measurement in the communication holding state.

When a voltage higher than a prescribed level is not measured, an abnormality of the communication line itself (e.g., the communication line is broken, the communication line is not connected, or the communication line is connected to a wrong connection port) is detected and a message indicating the abnormal state of the communication line is displayed on a display panel or the like. In addition, when a voltage higher than the prescribed level is not measured, switching is made to the connector on the external telephone 200 side by means of the relay function and it is attempted to measure a voltage of the communication line connected to the telephone 200 side.

When a voltage is detected (i.e., a voltage higher than the prescribed level is measured successfully) from the communication line to be used for a call (to be connected to the telephone 200), it is determined that the abnormality is due to connection of the communication line to a wrong connection port among the above-mentioned causes.

When an abnormality is detected in the above manner in a communication-disabled state, the communication holding state which has been maintained with the communication destination is canceled.

When a voltage higher than the prescribed level is not measured from the communication line to be used for a call, it is determined that the abnormality is due to non-connection of the communication line among the above-mentioned causes.

On the other hand, when a voltage higher than the prescribed level is measured successfully from the communication line to be used for a facsimile transfer from the facsimile apparatus 100, it is determined that a communication with the communication destination is not established for a certain reason though the communication line and is in a usable state, and a message to that effect is displayed on the display panel or the like. In this case, it is further determined after re-connection of the line whether a dial tone is detected or not. When a dial tone is detected, a selection signal which is one digit (one of 0 to 9, *, and #) or more of the dial number is sent to the communication destination and it is determined whether a dial tone is detected. When neither dial one is not detected, it is determined that the abnormality corresponds to a situation that a communication with the communication destination is not established for a certain reason though the communication line is in a usable state.

It is noted that the dial tone is a signal having a prescribed frequency which is sent continuously.

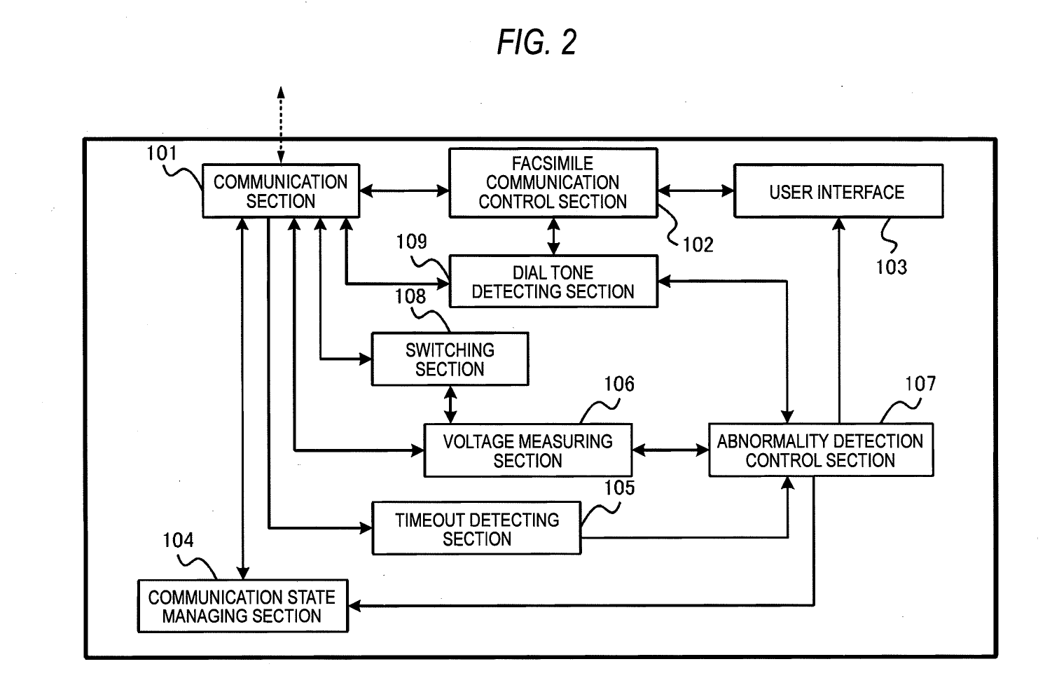

FIG. 2 shows the functional configuration of the facsimile apparatus 100 according to the exemplary embodiment of the invention.

As shown in FIG. 2, the facsimile apparatus 100 is composed of a communication section 101, a facsimile communication control section 102, a user interface 103, a communication state managing section 104, a timeout detecting section 105, a voltage measuring section 106, an abnormality detection control section 107, a switching section 108, and a dial tone detecting section 109.

For example, the user interface 103 is a display panel or is composed of a display and manipulation buttons. When the user specifies a dial number of a communication destination of a facsimile communication using manipulation buttons or the like, the user interface 103 gives the information of the specified dial number to the facsimile communication control section 102.

The facsimile communication control section 102 generates a selection signal by converting the dial number supplied from the user interface 103 into an electrical signal, which is transferred to the public switched telephone network which is connected via the communication section 101.

The communication section 101, which is a communication interface, is equipped with the telephone connection port 11 and the external line connection port 10 to each of which a communication line having an RJ-11 connector or the like is to be connected. The communication line extending from the telephone 200 is connected to the telephone connection port 11, and the communication line for connection to the public switched telephone network that leads to the exchange 300 provided in a telephone office is connected to the external line connection port 10.

The external line connection port 10 sends out the selection signal generated on the basis of the dial number and supplied from the facsimile communication control section 102, and receives a response to the selection signal.

After the selection signal generated on the basis of the dial number has been sent from the communication section 101, the communication state managing section 104 performs management so as to maintain a communication state established with the communication destination corresponding to the dial number. More specifically, a communication-standby state established with the communication destination is held and a communication with any other facsimile apparatus is disabled.

When a response of a facsimile communication is received from the communication destination via the external line connection port 10, the communication section 101 gives information to that effect to the facsimile communication control section 102. In response, the facsimile communication control section 102 generates image data for a facsimile communication and facsimile-transfers the generated image data (or image data generated in advance) to the communication destination.

On the other hand, when the timeout detecting section 105 detects a state (hereinafter also referred to as a T1 timeout) that a communication with the communication destination is not established while a communication holding state is maintained by the communication state managing section 104, the communication state managing section 104, the timeout detecting section 105 informs the abnormality detection control section 107 about the detection of the T1 timeout.

Based on an instruction from the abnormality detection control section 107, the voltage measuring section 106 checks, through a measurement, a voltage of the communication line to be used for a communication with the communication destination. For example, the voltage measuring section 106 measures a voltage by forming a DC loop circuit with the exchange 300 by rendering the facsimile apparatus 100 off-hook and measuring a loop current flowing through the loop circuit.

When succeeding in measuring a voltage that is higher than the prescribed level (i.e., has detected a voltage), the voltage measuring section 106 gives the information to that effect to the abnormality detection control section 107. The dial tone detecting section 109 judges whether or not it can detect a dial tone from the facsimile apparatus 100. When succeeding in detecting a dial tone, the dial tone detecting section 109 sends a selection signal which is one digit (one of 0 to 9, *, and #) or more of a dial number to the communication destination. Furthermore, the dial tone detecting section 109 judges whether or not it can detect a dial tone.

The dial tone detecting section 109 informs the abnormality detection control section 107 of a detection result(s).

When the detection results supplied from the dial tone detecting section 109 mean that neither dial tone is detected, the abnormality detection control section 107 determines that an abnormality has occurred that a communication with the communication destination is not established for a certain reason though the communication line is in a usable state. The abnormality detection control section 107 displays a message to that effect on the display of the user interface 103.

On the other hand, when not succeeding in measuring a voltage higher than the prescribed level, the voltage measuring section 106, the voltage measuring section 106 gives information to that effect to the switching section 108. The switching section 108 switches to the telephone-200-side connector which is connected to the communication section 101. This enables a measurement using the telephone-200-side connector.

After making the switching, the switching section 108 informs the voltage measuring section 106 about the switching to the telephone-200-side connector.

In response, the voltage measuring section 106 waits for a prescribed voltage stabilization time. After the voltage of the communication line for a communication involving the telephone 200 has been stabilized, the voltage measuring section 106 measures the voltage of the communication line.

The voltage measuring section 106 informs the abnormality detection control section 107 of a detection result.

Based on the measurement result supplied from the voltage measuring section 106, the abnormality detection control section 107 judges whether a voltage higher than the prescribed level is measured successfully or not. When judging that a voltage higher than the prescribed level is measured successfully, the abnormality detection control section 107 determines that the communication abnormality is due to erroneous connection of the communication line. When judging that a voltage higher than the prescribed level is not measured, the abnormality detection control section 107 determines that the communication abnormality is due to non-connection of the communication line.

The abnormality detection control section 107 displays a message indicating the detected abnormality on the display of the user interface 103. For example, when the detected abnormality is due to erroneous connection of the communication line, the abnormality detection control section 107 displays a message such as “Check for connection to an erroneous connection port.” When the detected abnormality is due to non-connection of the communication line, the abnormality detection control section 107 displays a message such as “The communication may not be connected to the connection port.”

After detecting details of the abnormality and displaying a corresponding message on the display, the abnormality detection control section 107 informs the communication state managing section 104 about the detection of the abnormality.

Receiving that information, the communication state managing section 104 cancels the managed state that the communication-standby state established with the communication destination is held.

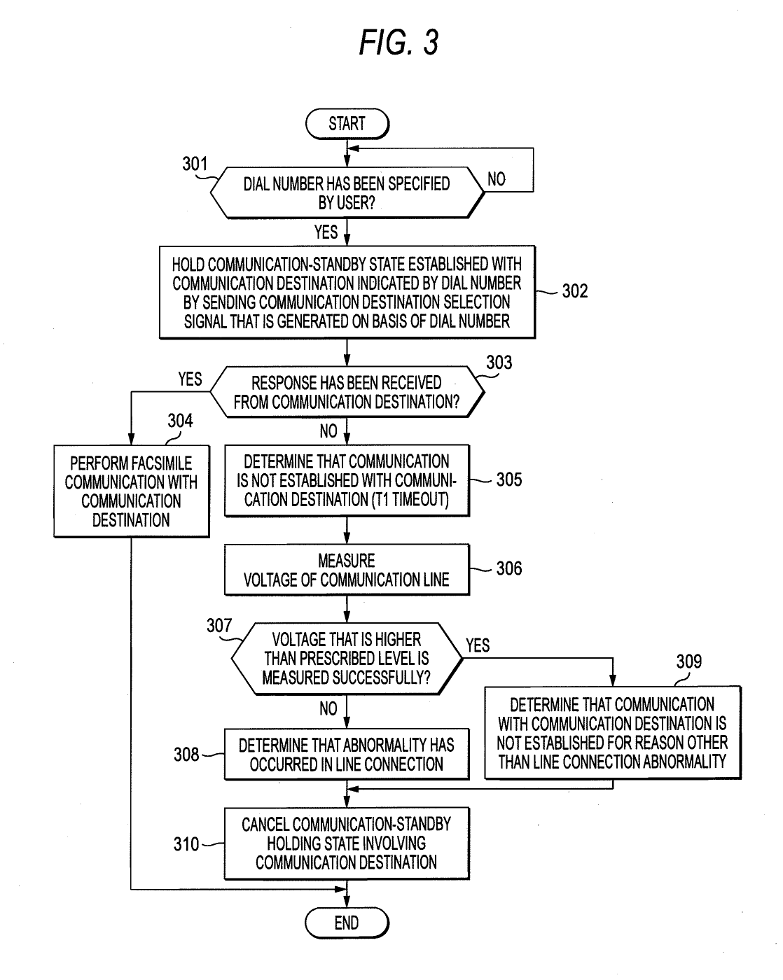

FIG. 3 is a flowchart of a process which is executed by the facsimile apparatus 100 according to the exemplary embodiment of the invention.

Referring to FIG. 3, the user manipulates dial buttons of the facsimile apparatus 100, whereupon the process is started. At step 301, it is determined whether or not a dial number which indicates a communication destination of a facsimile communication has been specified by manipulating dial buttons. When a dial number has been specified (step 301: yes), at step 302 a communication-standby state established with the communication destination is held by sending a selection signal (electrical signal) generated on the basis of the dial number to the communication destination via the communication line.

The selection signal is transmitted to the exchange provided in a telephone office via the communication line, subjected routing by the exchange 300, and transmitted to the communication destination corresponding to the dial number.

At step 303, it is determined whether or not a communication response to the selection signal has been received from the communication destination. When a communication response has been received (step S303: yes), at step S304 a communication is established with the communication destination and a facsimile communication is performed.

On the other hand, when no communication response has been received from the communication destination (step 303: no), at step 305 it is determined that a communication is not established with the communication destination (T1 timeout).

At step 306, a voltage of the communication line that transmits the selection signal is measured. At step 307, it is determined whether or not a voltage that is higher than the prescribed level is measured successfully. When a voltage higher than the prescribed level is measured successfully (step 307: yes), at step 309 it is determined that a communication with the communication destination is not established for a reason other than a line connection abnormality.

On the other hand, when no voltage higher than the prescribed level is measured (step 307: no), it is determined that an abnormality has occurred in the line connection. Example abnormalities in the line connection are a communication abnormality due to non-connection of a communication cable and a communication abnormality due to erroneous connection of a communication cable.

When a communication abnormality is detected in the above-described manner, a message to that effect is, for example, displayed on the display of the user interface 103. At step 310, the communication holding state involving the communication destination is canceled.

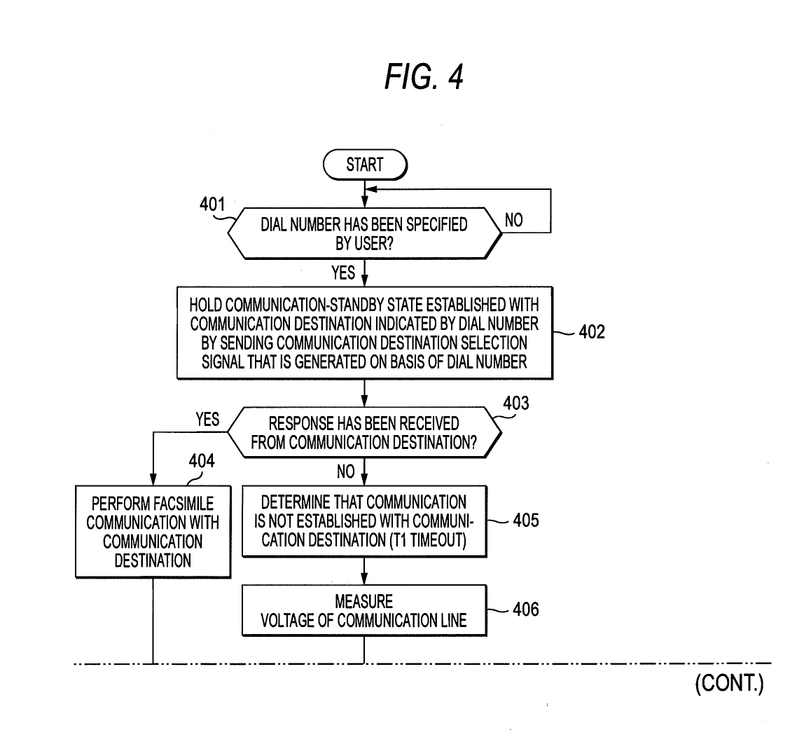

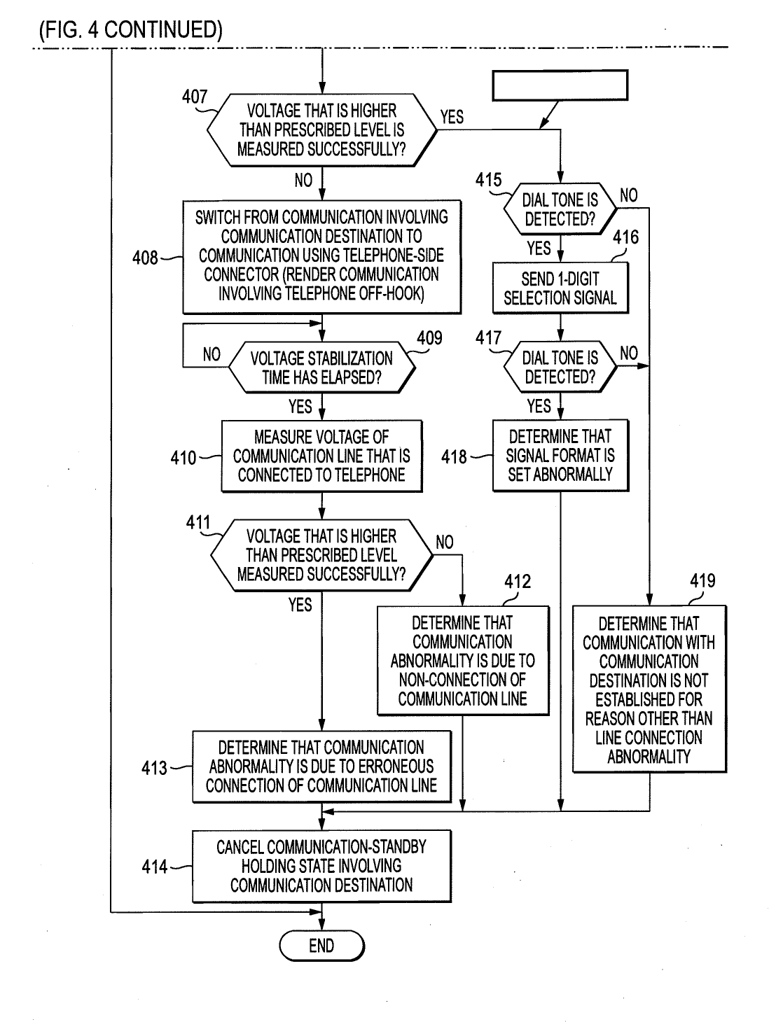

FIG. 4 is a flowchart of another process which is executed by the facsimile apparatus 100 according to the exemplary embodiment of the invention.

Referring to FIG. 4, the user manipulates dial buttons of the facsimile apparatus 100, whereupon the process is started. At step 401, it is determined whether or not a dial number which indicates a communication destination of a facsimile communication has been specified by manipulating dial buttons. When a dial number has been specified (step 401: yes), at step 402 a communication-standby state established with the communication destination is held by sending a selection signal (electrical signal) generated on the basis of the dial number to the communication destination via the communication line.

The selection signal is transmitted to the exchange 300 provided in a telephone office via the communication line, subjected routing by the exchange 300, and transmitted to the communication destination corresponding to the dial number.

At step 403, it is determined whether or not a communication response to the selection signal has been received from the communication destination. When a communication response has been received (step S403: yes), at step S404 a communication is established with the communication destination and a facsimile communication is performed.

On the other hand, when no communication response has been received from the communication destination (step 403: no), at step 405 it is determined that a communication is not established with the communication destination (T1 timeout).

At step 406, a voltage of the communication line that transmitted the selection signal is measured. At step 407, it is determined whether or not a voltage that is higher than the prescribed level is measured successfully. When no voltage higher than the prescribed level is measured (step 407: no), at step S408 switching is made from a communication with the communication destination via the communication line to a communication with the external telephone 200. That is, a communication involving the facsimile apparatus 100 is rendered on-hook (disconnection to the connection line) and a communication involving the telephone 200 is rendered off-hook (connection to the connection line).

At step 409, it is determined whether or not a voltage stabilization time (e.g., 1 or 5 sec) that is taken until the voltage of the communication for a communication involving the telephone 200 is stabilized. When the voltage stabilization time has not elapsed yet (step 409: no), the process stands by until stabilization of the voltage. When the voltage stabilization time has already been elapsed (step 409: yes), at step 410 a voltage of the communication line for a communication involving the telephone 200 is measured.

At step 411, it is determined whether or not a voltage that is higher than the prescribed level is measured successfully. When a voltage higher than the prescribed level is measured successfully (step 411: yes), at step 413 it is determined that the communication abnormality is due to erroneous connection of the communication line.

When no voltage higher than the prescribed level is measured (step 411: no), at step 412 it is determined that the communication abnormality is due to non-connection of the communication line.

When a communication abnormality is detected in the above-described manner, a message to that effect is, for example, displayed on the display of the user interface 103. At step 414, the communication holding state involving the communication destination is canceled.

On the other hand, when it is determined at step 407 that a voltage higher than the prescribed level is measured successfully at step 406 (step 407: yes), then it is determined at step 415 whether or not a dial tone is detected after re-connection of the line.

When a dial tone is detected (step 415: yes), at step 416 a selection signal of one digit (one of numbers 0 to 9) is sent. At step 417, it is again determined whether or not a dial tone is detected. When a dial tone is detected again (step 417: yes), at step 418 it is determined that the format of a signal to be used for a facsimile communication is set abnormally.

More specifically, it is determined that the abnormality is caused because the format of a signal to be used for a facsimile communication is set to the PB (push button) type though it should be set to the DP (dial pulse) type or vice versa.

When no dial tone is detected at step 415 or 417, at step 419 it is determined that a communication with the communication destination is not established for a reason other than a line connection abnormality.

The above-described exemplary embodiment is just one embodiment of the invention. That is, the invention is not limited to the above exemplary embodiment and various modifications are made as appropriate without departing from the spirit and scope of the invention.

According to the invention, a facsimile communication system is constructed which executes the above-described process by installing programs for implementing the above-described means in a computer from a recording medium (e.g., CD-ROM or DVD-ROM) and causing the computer to run those programs. In the computer as part of the facsimile communication system, a CPU (central processing unit), a ROM (read-only memory), and a RAM (random access memory), and a hard disk drive are connected to each other by a system bus. The CPU operates according to programs stored in the ROM or the hard disk drive using the RAM as a work area.

The media for supplying the programs may be a communication medium (i.e., a medium that holds the programs temporarily or in a flowable manner, such as a communication line or a communication system). For example, the programs may be posted in a bulletin board service (BBS) and delivered over a communication line.

The foregoing description of the exemplary embodiment of the present invention has been provided for the purpose of illustration and description. It is not intended to be exhaustive or to limit the invention to the precise forms disclosed. Obviously, many modifications and various will be apparent to practitioners skilled in the art. The embodiments were chosen and described in order to best explain the principles of the invention and its practical application, thereby enabling other skilled in the art to understand the invention for various embodiments and with the various modifications as are suited to the particular use contemplated. It is intended that the scope of the invention be defined by the following claims and their equivalents.

What is claimed is:

1. A facsimile apparatus comprising:
a first detecting unit that detects whether a facsimile communication is established or not with a communication destination in a prescribed time after a selection signal is sent to the communication destination with a communication line held; and
a second detecting unit that detects a state of the communication line with the communication line held when the first detecting unit detects that a facsimile communication is not established.

2. The facsimile apparatus according to claim 1, wherein the second detecting unit includes:
a voltage checking unit that checks a voltage of the communication line; and
a determination unit that determines that a line abnormality arises when the voltage checking unit detects that the voltage of the communication line is abnormal, and determines that a failure other than a line abnormality arises when the voltage checking unit detects that the voltage of the communication line is normal.

3. The facsimile apparatus according to claim 1, wherein the second detecting unit includes:
a voltage checking unit that checks a voltage of the communication line; and
a determination unit that switches the connection to an external-telephone-side connector using a relay circuit and causes the voltage checking unit to check a voltage of the communication line again when the voltage checking unit detects that the voltage of the communication line is abnormal, determines that the communication line is not connected when the voltage checking unit again detects that the voltage of the communication line is abnormal and, determines that the communication line is connected erroneously when the voltage checking unit detects this time that the voltage of the communication line is normal.

4. The facsimile apparatus according to claim 1, wherein the second detecting unit includes:
a voltage checking unit that checks a voltage of the communication line; and
a determination unit that tries to detect a dial tone after reconnection of the communication line when the voltage checking unit detects that the voltage of the communication line is normal, and determines that a failure other than a line abnormality arises when not detecting a dial tone.

5. The facsimile apparatus according to claim 1, wherein the second detecting unit includes:
a voltage checking unit that checks a voltage of the communication line; and
a determination unit that tries to detect a dial tone by sending out a selection signal after reconnection of the communication line when the voltage checking unit detects that the voltage of the communication line is normal, determines that a failure other than a line abnormality arises when not detecting a dial tone, and determines that an erroneous line setting is made when detecting a dial tone.

6. The facsimile apparatus according to claim 1, wherein the second detecting unit includes:
a voltage checking unit that checks a voltage of the communication line;
a first determination unit that switches the connection to an external-telephone-side connector using a relay circuit and causes the voltage checking unit to check a voltage of the communication line again when the voltage checking unit detects that the voltage of the communication line is abnormal, determines that the communication line is not connected when the voltage checking unit again detects that the voltage of the communication line is abnormal, and determines that the communication line is connected erroneously when the voltage checking unit detects this time that the voltage of the communication line is normal;
a second determination unit that tries to detect a dial tone after reconnection of the communication line when the voltage checking unit detects that the voltage of the communication line is normal, and determines that a failure other than a line abnormality arises when a dial tone is not detected; and
a third determination unit that again tries to detect a dial tone by sending out a selection signal when the second judging unit detects a dial tone, determines that a failure other than a line abnormality arises when not detecting a dial tone, and determines that an erroneous line setting is made when detecting a dial tone again.

7. A failure detection method comprising:
detecting whether a facsimile communication is established or not with a communication destination in a prescribed time after a selection signal is sent to the communication destination with a communication line held; and
detecting a state of the communication line with the communication line held when the first detecting unit detects that a facsimile communication is not established.

8. A computer readable medium storing a program causing a computer to execute a process for failure detection, the process comprising:
detecting whether a facsimile communication is established or not with a communication destination in a prescribed time after a selection signal is sent to the communication destination with a communication line held; and
detecting a state of the communication line with the communication line held when the first detecting unit detects that a facsimile communication is not established.
